(19) United States
(12) Patent Application Publication
(10) Pub. No.: US 2008/0010150 A1
(43) Pub. Date: Jan. 10, 2008

(54) Creative advertising process for flow of sponsored advertising monies

(76) Inventor: Michael D. Blackman, Florence, SC (US)

Correspondence Address: Mike Blackman, P.O. Box 65, Florence, SC, 29503-0065, US

(21) Appl. No.: 11/581,155

(22) Filed: Aug. 23, 2006

Related U.S. Application Data
(60) Provisional application No. 60/818,439, filed on Jul. 5, 2006.

(51) Int. Cl. G06Q 90/00; G06Q 30/00

(52) U.S. Cl. 705/14; 705/27

(57) ABSTRACT

A method or methods of operating a communication systems or systems comprising multiple steps which relate to a wiring and software plan that lays the groundwork for new advertising processes and systems that introduce government to advertising causing new patentable claims in the international global market-place.

New claims introduce complex methods and systems that create new advertising processes, existing network services including call profile and sponsor selection interaction with caller and controlled access to network services finally providing for existing systems and methods of billing by the sponsor via consumer that could expand to a new system or systems providing for new methods, etc.

The applicant maintains that the original simple claim of the exchange of copyrighted advertising for information, fees, etc. expanded to include complex systems and methods would have to lay the groundwork for new advertising patents involving new systems and methods which could become part of new patented soft-ware as part of new international patents having new soft-ware, systems and new methods.

### TECHNICAL FIELD

This invention relates to systems for providing telephone marketing services including new methods of business connected to said systems beginning with an exchange of material in lists providing for an exchange of money for copyrighted ad messages.

### PROBLEM

To create multiple claims that possibly introduce advertising as an art. These claims address issues of international concern in advertising. The specification that laid the foundation for these claims was filed in December of 84 when the applicant's rough initial claim was filed.

This claim allowed for a complete process of advertising and an exchange of money, even government money, when the consumer accepted copyrighted advertising messages for calls/and/or information.

Over the years, the applicant's application expanded becoming more sophisticated with possible [symbol] elaborate systems and more complex methods evolving.

Several new claims using these [symbol] materials evolved.

With the evolution of the new materials, evolved new implied contracts with the consumer to agency, sponsors, business, patentable machines, etc. These materials were included in the applicant's abstract.

Also included in the applicant's original specification were government materials which the applicant maintains laid the groundwork for dealing with the government involving government laws, fees, etc. The government groundwork being bankruptcy papers and money relating to the original application—money being paid to the government which was listed and made part of the original patent specification.

### (a) TITLE OF THE INVENTION

### Creative advertising process for flow of sponsored advertising monies.

### (b) CROSS-REFERENCE TO RELATED APPLICATIONS

### On attached Patent Statement Sheet

### (c) STATEMENT REGARDING SPONSORED RESEARCH OR DEVELOPMENT

The application was made public and it is coded V- Hat- U N G-I D through the American Medical Association. The applicant believes that considerable monies have been spent on the application which is an International Application.

### (d) INCORPORATION-BY-REFERENCE OF MATERIAL SUBMITTED ON A COMPACT DISC

Not submitted by the applicant-

### (e) BACKGROUND OF THE INVENTION

(1) Applicant's original claim was rejected as being unpatentable over Dunning (U.S. Pat. No. 3,111,561) and Segre Amar (U.S. Pat. No. 3,4,510,349) in view of Winkleman (U.S. Pat. No. 4,451,704).

In these patents the examiner stated arrangements for answering “intercepting calls” with an advertisement provided for the consumer.

The applicant maintains that his application offered the first application that provided for information exchanged monetarily for an advertising message and not just “machine interpretations” with announcements providing no complete process.

The applicant maintains that since his initial filing, there have been granted numerous international patents which evolved from his simple idea.

Rejected as “new matter” in the applicant's application were replies from the consumer to the sponsor with possible rebates.

Also rejected were replies from sponsor to business with possible replies and/or rebates back and forth, etc.

In the applicant's original simple specification were included “Paid Sponsors” which paid for advertising and which the applicant maintained could be a part of the “new advertising process”.

In the New Matter of the applicant's specification there existed a reply or replies from the paid sponsor to business or businesses possibly involving a rebates or rebates.

Applicant maintains that this reply is a “first in advertising” and that, although simple, it should not be listed as part of 35 U.S.C. 103 (a) which forms the basis for all obviousness rejections.

When the applicant worked on his simple application, he based his plans for using groceries and stores using sponsors and rebates.

In order to separate and explain a “Paid Sponsor” from business and businesses, applicant will illustrate as follows; in a grocery store are numerous products with discounts and some which are sponsored by the store; a sponsored reply to business which is new and which is separated from “Paid Sponsor” could be a reply to a bank or banking service that could offer replies or rebates.

The applicant maintains that this service is new and unobvious and that there exists numerous such examples that could be used by professionals that would separate “Paid Sponsor” from “Business”.

The applicant also maintains that numerous marketing examples could be “new and useful” by professional marketing representatives.

Conception to practice of the applicant's new matter began before Jan. 25, 2005 when his rough materials were recorded in the Patent Office coded TRRELL-1-703-305-4573.

Unfortunately, [symbol] business being as it is, the applicant believes that his ideas are again in court causing numerous monetary problems for the U.S.

Applicant added two new ideas to his simple application:

1) the use of nine-digit zip codes relating to business and consumer

2) Addition and feedback of replies, advertising, money, etc. through the government

Applicant maintains that this idea, although simple, is not obvious being very useful and possibly new internationally.

Applicant maintains that he did diligently try to put his simple application into practice—first by trying to hire competent agents and by even trying [symbol] to place his application for use on a percentage basis in exchange for work.

The applicant had no choice to save and try to prosecute the application himself—mostly to keep busy and to use the application as a tool to keep his mind clear.

The applicant maintains that these new additions to his application, although simple, were necessary to complete the application and make it competitive in the international marketplace.

### (2) DESCRIPTION OF THE RELATED ART

Since the applicant's simple filing of his application, numerous patents have been granted that relate and incorporate the applicant's simple ideas.

Many of these applications have elaborate software and wiring which, in itself, are patented.

These patents contain numerous systems which are elaborate, and incorporated within these systems are methods [symbol] which contain elaborate wiring.

The applicant maintains that many of these methods originated with his application.

The most recent system and method being feedback of replies/rebates/etc. of sponsor to business.

Also: The applicant's application was a first when incorporating rebates from the sponsor and business to the consumer within a system that allowed for the method of an exchange of information and copyrighted advertising messages which could be expanded into a marketing system allowing [symbol] for rebates and/or trades through the telephone.

The applicant maintains that these patented systems and methods could even relate to the internet as both contain similar ideas, patented wiring, and software with systems and methods included.

### (f) BRIEF SUMMARY OF THE INVENTION

The invention began with a rough specification (rough schematic diagram) that mixed patentable machine (prior art) with Art in Process (Database) and connect to business (sponsor) with an individual method of business (consumer to sponsor) or back to directory machine (consumer copyrighted names, etc.) with advertising and information exchanged via a possible monetary contract (a simple system including an individualized method of business).

The system was made more complex by adding business replying to sponsor with possible rebates and including the individual system already claimed with sponsor back to consumer with possible replies or rebates with the said exchange of information for advertising with a possible monetary contract on an individual level and not as part of an media blitz as is included in most advertising campaigns. The system is outlined in drawing FIG. 1 by the applicant.

The invention was made more complex by adding government which outlined an additional claim which [symbol] included possible replies and rebates from government to business and sponsor going to consumer (could use Patentable Machines—prior art).

### (g) BRIEF DESCRIPTION OF SEVERAL VIEWS OF THE DRAWINGS

FIG. 1 illustrated the applicant's first rough system which outlined consumer replying to sponsor often with rebates (possibly via patentable machine—prior art) and sponsors to directory machine—prior art) which is a consumer database—new art in progress with consumer copyrighted names and address—ALSO ILLUSTRATED IS COPYRIGHTED ADVERTISING that is exchanged for information on an individualized basis.

FIG. 4 illustrates how sponsors could move back and forth to individual consumer in the system outlined in FIG. 1 which contained the applicant's original claim which included a simple method of advertising.

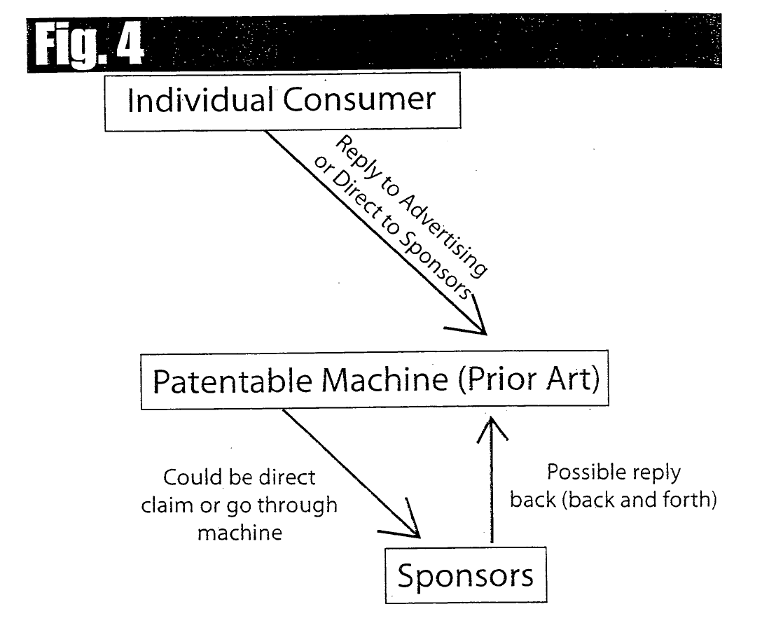

In FIG. 5 the application illustrates how business could interact with the sponsor or consumer to produce added benefits and an additional method which outlines another claim.

FIG. 6 adds government to the application which can make replies to Business or Sponsors producing another distinct and new claim.

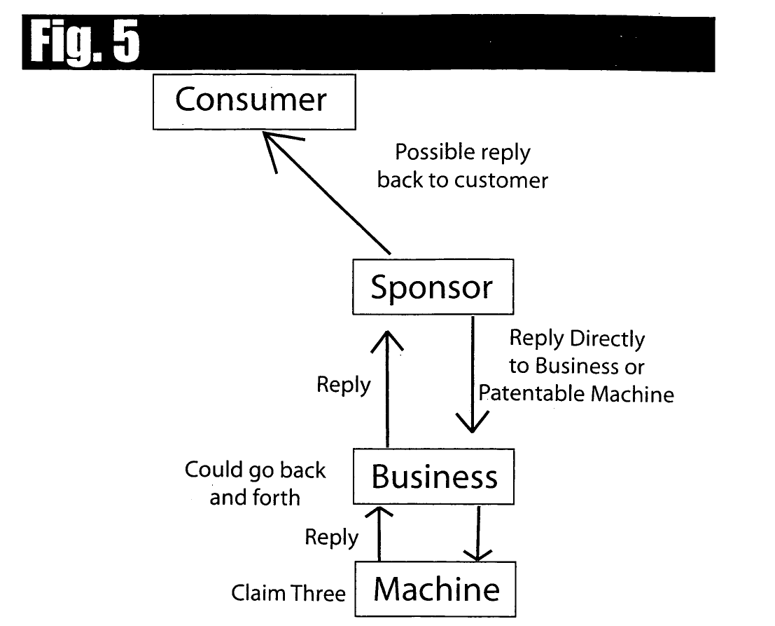

FIG. 7 outlines the Original Specification which included consumer database and sponsor (connected to business) with the original advertising system and methods of FIG. 1 expanded to include new and more improved systems and methods.

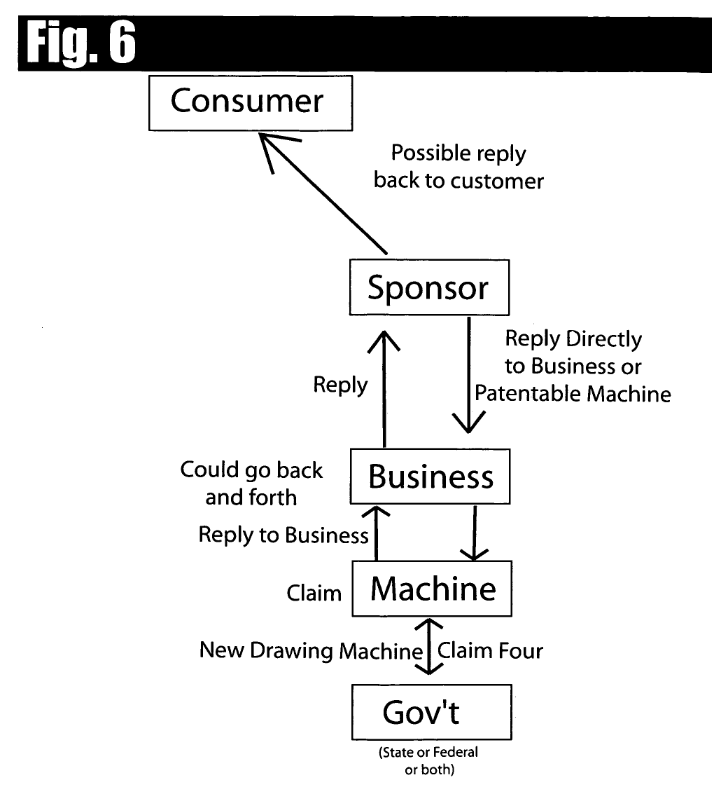

FIG. 7 outlines a very simple wiring and software plan which the applicant hopes will lay the groundwork for complex wiring and software which the applicant believes will have to be added before the application is patented. Nine digit zip codes are introduced as well as computers, modems, and telephone wiring.

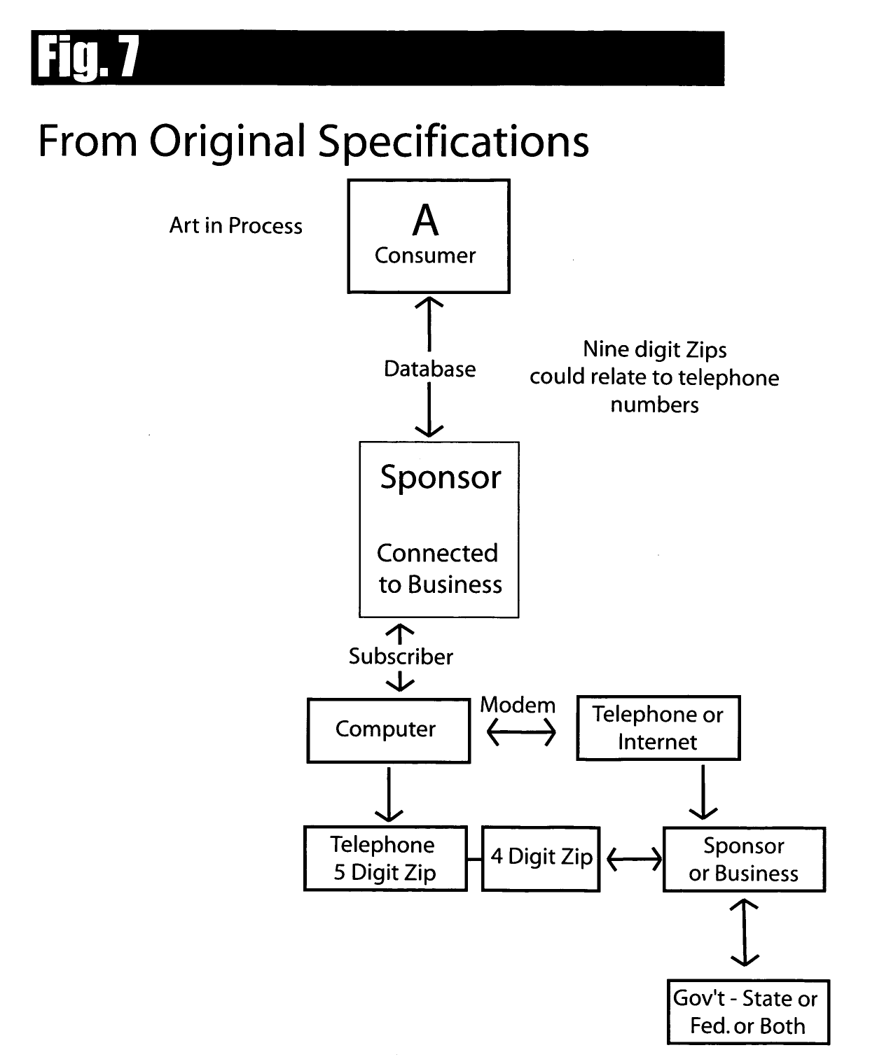

The applicant feels that his simple wiring and software package is self explanatory and only provides the basis to add a case for the applicant that will stop an examiner's ruling of “New Matter, etc.”

FIG. 8 is complex wiring and software that then applicant maintains could be added to the application as New Systems and Methods to be incorporated as “New Matter” that will replace the applicant's simple “System and Methods” of FIG. 1 which was the basis for the original specification.

### (h) DETAILED DESCRIPTION OF THE INVENTION

The invention began with a simple claim which initiated an individualized advertising campaign which exchanged copyrighted advertising messages for free or reduced rate information or calls using telephone line or lines that are leased or owned. The campaign incorporated implied contracts from the consumer to the sponsor or agency and the application expanded to include more sophisticated contracts involving rebate or rebates with consumer, agency, sponsor, business, government, etc.

Art in process within the application expanded causing more sophistication with a national data base added that included zip codes being expanded to include nine digit codes as well as the codes within the application (00, 411, 555-1212, etc.).

Art in process now incorporates magnificent new [symbol] ideas and technology where the consumer interacts with machine—machines that use “voice” mechanisms to understand words and phrases and then to reply often expanding into more implied contracts with the consumer, sponsor, business, government, etc.

The applicant's application expanded as the applicant tried to incorporate these “new ideas” that would fit in with this new technology being introduced internationally into the global marketplace.

Although the applicant's ideas are simple, the applicant maintains that his new ideas added to the marketability of international ideas and processes.

One simple idea being the interaction of business and replies or rebates to sponsor and consumer. The applicant maintains this idea was his being simple and unobvious as it was used to reply to the “Paid Sponsor” after the applicant introduced the process to the international marketplace. The applicant's patent application was filed which leads him to believe that a search was made showing that his conception to practice of the idea was somewhat unique—to say the least.

The applicant waited approximately two years before filing his application having started conception to practice in an old rejected application.

Unfortunately, the applicant feels that his ideas are again in court possibly costing the U.S. valuable time and money.

The applicant's final “new and simple” international idea is the use of government as related to advertising.

Government could be used as a tool in advertising [symbol] advertising campaigns causing possible replies and rebates to go to business and sponsor that could finally reach the consumer.

The applicant maintains this “new ideA”, although simple, is unobvious because it is possibly new internationally, and then idea has worth—possibly causing a new search to be conducted by the patent and trademark office.

Being new and un-introduced to the marketplace would mean the idea would not be in court.

Finally, the applicant would like to state that, in his new application, that the applicant tried to incorporate simple wiring and software that would lay the groundwork for technology that would stop an examiner's ruling “New Matter” which could cause the applicant's application to be totally rejected and force the applicant to “scrap the application due to another “new matter” ruling.

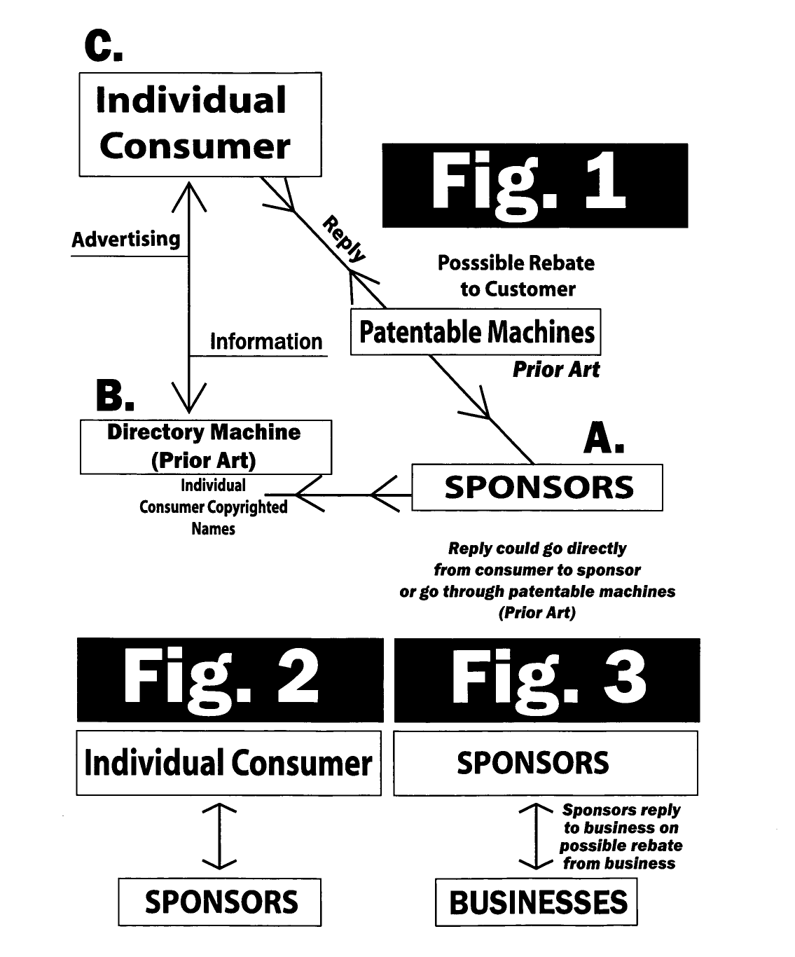

Incorporated within the application, are the simple systems and methods found in FIG. 1, FIG. 2 and FIG. 3 which were simple and which did not include wiring and software.

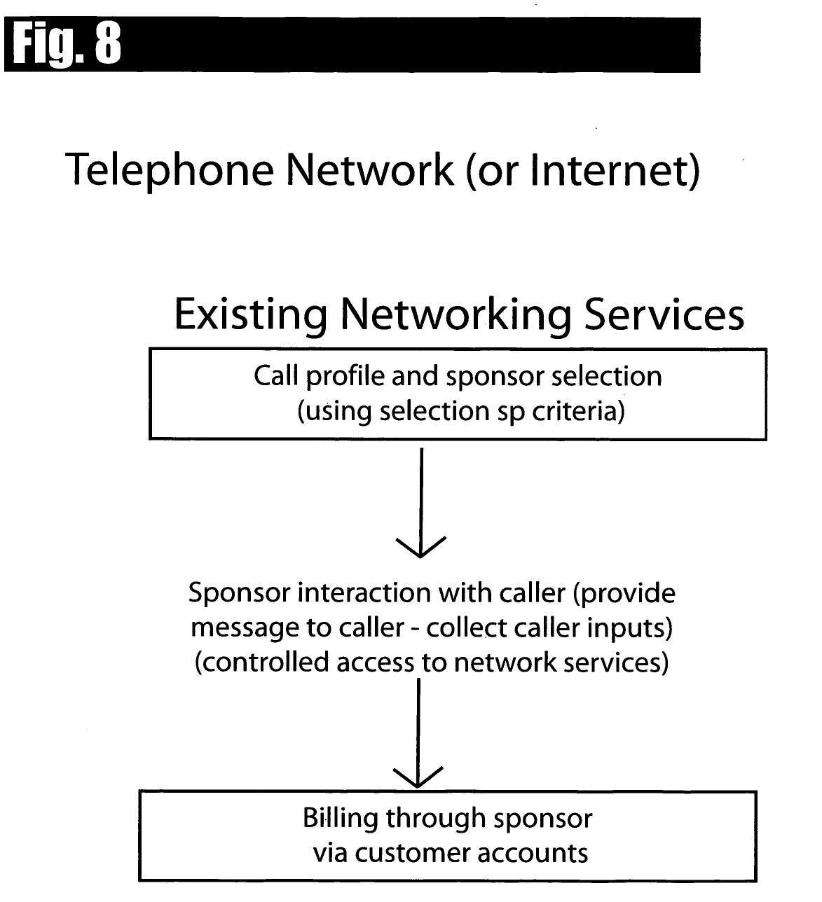

Replaced, in the applicant's new application is a simple [symbol] wiring and software plan that incorporates an elaborate and “somewhat new” outgrowth of software found in FIG. 8 which should include new systems and methods that hopefully will stop “a New Matter” rejection from an examiner.

I claim:

1. A new and useful process of advertising is created based on the principle that an information system or system can provide the basis for an individualized method or methods of advertising a product or products comprising multiple ingredients which are copyrighted lists or directories with individual copyrighted names and addresses (now possible of new laws relating to lists) and individual line or lines that [symbol] interact with the individual consumer that allow for implied contracts to be formed with consumer to agency, sponsor, business, government, etc. that provide interactions providing for paid fees and new marketing procedures over the phone based on the original contract whereas information or fees are exchanged in the said marketing contracts when the consumer agrees to listen to an advertising message.

2. A telephone toll system or systems containing a method or methods in which a reply or replies is generated from the consumer back to the sponsor (could be multiple replies back and forth) after the consumer agrees to receive advertising in the form of copyrighted advertising messages in which the consumer could respond to said advertising by asking for more information or by receiving a rebate or rebates either by means of patentable machine (prior art) or by responding directly to the sponsor.

3. A telephone toll system or systems containing a method or methods where as a possible reply can be generated from the “Paid Sponsor” directly to “Business or Businesses” which are separate and distinct from “Paid Sponsor” and causing possible multiple replies to exist with possible rebate or rebates (possibly back and forth) from “Paid Sponsor” to “Business” either direct or through patentable machine (prior art) which can add additional benefits to the consumer or add new benefits to the “Paid Sponsor” and business as well as back again to the consumer.

4. A method or methods of operating a communication system comprising multiple steps which connect said methods to new patentable systems and methods where as a simple wiring and software plan is introduced that lays the groundwork for these new advertising processes and systems that introduce government to advertising causing new patentable claims to be file in the art; these new claims introduce new systems and methods, more importantly, complex systems and methods which include government claims connected to sponsor or business with replies or rebates including methods of sponsor selection, sponsor interaction with caller (providing advertising to caller with caller inputs included) and finally including a system that would incorporate a method of billing through sponsor via customer accounts with sponsor paying the fees by the use of copyrightable advertising messages, etc.
